(19) United States
(12) Patent Application Publication
(10) Pub. No.: US 2025/0294557 A1
(43) Pub. Date: Sep. 18, 2025

(54) TRANSMISSION CONTROL METHOD AND APPARATUS, NETWORK SIDE DEVICE, AND TERMINAL DEVICE

(71) Applicant: VIVO MOBILE COMMUNICATION CO., LTD., Dongguan (CN)

(72) Inventor: Jiamin LIU, Dongguan (CN)

(73) Assignee: VIVO MOBILE COMMUNICATION CO., LTD., Dongguan (CN)

(21) Appl. No.: 19/227,444

(22) Filed: Jun. 3, 2025

Related U.S. Application Data
(63) Continuation of application No. PCT/CN2023/136019, filed on Dec. 4, 2023.

(30) Foreign Application Priority Data
Dec. 9, 2022 (CN) 202211593821.1

(51) Int. Cl. H04W 72/20; H04W 76/20; H04W 92/18

(52) U.S. Cl. CPC H04W 72/20; H04W 76/20; H04W 92/18

(57) ABSTRACT

A transmission control method and apparatus, a network side device, and a terminal device are provided. The transmission control method includes: a target device sends first control signaling to a remote device through a direct path between the target device and the remote device, where the first control signaling includes a first indication used for activating or deactivating duplication transmission of a target bearer of the remote device. The target bearer is a bearer for at least two transmission paths of the remote device, and the at least two transmission paths comprise the direct path and at least one indirect path between the target device and the remote device.

### CROSS-REFERENCE TO RELATED APPLICATIONS

This application is a continuation of International Application No. PCT/CN2023/136019, filed Dec. 4, 2023, which claims priority to Chinese Patent Application No. 202211593821.1, filed Dec. 9, 2022. The entire contents of each of the above-referenced applications are expressly incorporated herein by reference.

### TECHNICAL FIELD

This application pertains to the field of communication technologies, and specifically relates to a transmission control method and apparatus, a network side device, and a terminal device.

### BACKGROUND

A relay technology in a wireless communication system is to add one or more relay nodes between a base station and a terminal to be responsible for forwarding a wireless signal one or more times, that is, the wireless signal needs to pass through a plurality of hops to reach the terminal.

The wireless relay technology can be used not only to extend cell coverage and make up for cell coverage blind spots, but also to improve a cell capacity through spatial resource reuse. For indoor coverage, the relay technology can overcome a penetration loss and improve indoor coverage quality.

In an example of simple two-hop relay, wireless relay is to divide a base station-terminal link into two links: base station-relay station and relay station-terminal, so that a poor-quality link can be replaced with two good-quality links to obtain a higher link capacity and better coverage.

In scenarios where the wireless relay technology is used, there is no solution for implementing duplication transmission and path control.

### SUMMARY

Embodiments of this application provide a transmission control method and apparatus, a network side device, and a terminal device, to implement dynamic control on duplication transmission and/or a transmission path of a remote device in a wireless relay scenario.

According to a first aspect, a transmission control method is provided, including:
sending, by a target device, first control signaling to a remote device through a direct path between the target device and the remote device, where the first control signaling includes at least one of the following:
a first indication, where the first indication is used for activating or deactivating duplication transmission of a target bearer of the remote device; or
a second indication, where the second indication indicates a primary path/secondary path.

According to a second aspect, another transmission control method is provided, including:
locally generating, by a remote device, a configuration policy, and performing transmission configuration according to the configuration policy; or
performing, by the remote device, transmission configuration according to a control instruction when receiving the control instruction sent by a target device; where
the configuration policy or the control instruction includes at least one of the following:
a first indication, where the first indication is used for activating or deactivating duplication transmission of a first target bearer of the remote device; or
a second indication, where the second indication indicates a primary path/secondary path.

According to a third aspect, a transmission control apparatus is provided, including:
a first control signaling sending module, configured to send first control signaling to a remote device through a direct path to the remote device, where the first control signaling includes at least one of the following:
a first indication, where the first indication is used for activating or deactivating duplication transmission of a target bearer of the remote device; or
a second indication, where the second indication indicates a primary path/secondary path.

According to a fourth aspect, another transmission control apparatus is provided, including:
a first configuration module, configured to locally generate a configuration policy, and perform transmission configuration according to the configuration policy; or
a second configuration module, configured to perform transmission configuration according to a first control instruction when receiving the first control instruction sent by a target device.

The configuration policy or the first control instruction includes at least one of the following:
a first indication, where the first indication is used for activating or deactivating duplication transmission of a first target bearer of the remote device; or
a second indication, where the second indication indicates a primary path/secondary path.

According to a fifth aspect, a terminal device is provided, where the terminal includes a processor and a memory, the memory stores a program or instructions capable of running on the processor, and the program or the instructions are executed by the processor to implement the steps of the transmission control method according to the first aspect or the second aspect.

According to a sixth aspect, a network side device is provided. The network side device includes a processor and a memory. The memory stores a program or instructions capable of running on the processor, and the program or the instructions are executed by the processor to implement the steps of the transmission control method according to the first aspect.

According to a seventh aspect, a transmission control system is provided, including a network side device and a terminal device. The network side device may be configured to perform the steps of the transmission control method according to the first aspect, and the terminal device may be configured to perform the steps of the transmission control method according to the second aspect.

According to an eighth aspect, a readable storage medium is provided, where a program or instructions are stored in the readable storage medium, and the program or the instructions are executed by a processor to implement the steps of the method according to the first aspect or the steps of the transmission control method according to the second aspect.

According to a ninth aspect, a chip is provided. The chip includes a processor and a communication interface. The communication interface is coupled to the processor, and the processor is configured to run a program or instructions to implement the transmission control method according to the first aspect or implement the transmission control method according to the second aspect.

According to a tenth aspect, a computer program/program product is provided. The computer program/program product is stored in a storage medium. The computer program/program product is executed by at least one processor to implement the steps of the transmission control method according to the first aspect or the second aspect.

According to an eleventh aspect, a transmission apparatus/device is provided, including steps that the apparatus/device is (configured) to perform to implement the transmission control method according to the first aspect or the second aspect.

In embodiments of this application, the target device may send the first control signaling to the remote device through a direct path, where the first control signaling includes the first indication and/or the second indication, the first indication is used for activating or deactivating the duplication transmission of the target bearer of the remote device, and the second indication indicates a primary path/secondary path. The target device may control, by using the first control signaling, the remote device to activate or deactivate the duplication transmission of the target bearer and/or change a primary path, so as to flexibly use each transmission path, thereby improving data transmission efficiency.

### BRIEF DESCRIPTION OF DRAWINGS

FIG. 1 is a block diagram of a wireless communication system applicable to an embodiment of this application;

FIG. 2 is a schematic diagram of a UE-to-Network relay scenario according to an embodiment of this application;

FIG. 3 is a schematic diagram of a multi-path scenario based on a UE relay architecture according to an embodiment of this application;

FIG. 4 is a flowchart of a transmission control method according to an embodiment of this application;

FIG. 5 is a schematic diagram of a format of control signaling according to an embodiment of this application;

FIG. 6 is a schematic diagram of a format of another type of control signaling according to an embodiment of this application;

FIG. 7 is a flowchart of another transmission control method according to an embodiment of this application;

FIG. 8 is a block diagram of a structure of a transmission control apparatus according to an embodiment of this application;

FIG. 9 is a block diagram of a structure of another transmission control apparatus according to an embodiment of this application;

FIG. 10 is a block diagram of a structure of a communication device according to an embodiment of this application;

FIG. 11 is a block diagram of a structure of a terminal device according to an embodiment of this application;

FIG. 12 is a block diagram of a structure of a network side device according to an embodiment of this application; and

FIG. 13 is a block diagram of a structure of another network side device according to an embodiment of this application.

### DETAILED DESCRIPTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in the specification and claims, “and/or” represents at least one of connected objects, and the character “/” generally represents an “or” relationship between associated objects.

It should be noted that, a technology described in embodiments of this application is not limited to a Long Term Evolution (LTE)/LTE-advanced (LTE-A) system, and may be further applied to other wireless communication systems, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. The terms “system” and “network” are often used interchangeably in the embodiments of this application. A technology described may be used for the systems and radio technologies described above, as well as other systems and radio technologies. The following describes a New Radio (NR) system for illustrative purposes, and NR terms are used in most of the following descriptions. However, these technologies are also applicable to applications such as a 6^{th} Generation (6G) communication system other than NR system applications.

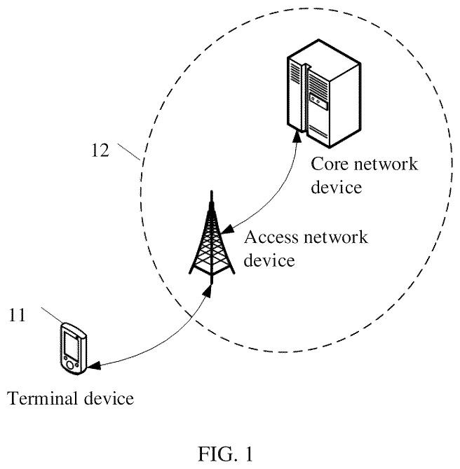

FIG. 1 is a block diagram of a wireless communication system applicable to an embodiment of this application. The wireless communication system includes a terminal device 11 and a network side device 12. The terminal device 11 may be a mobile phone, a tablet personal computer, a laptop computer also referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a laundry machine, or a furniture), a gaming console, a personal computer (PC), a teller machine, a self-service machine, or another terminal side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal device 11 is not limited in this embodiment of this application. The network side device 12 may include an access network device or a core network device. The access network device 12 may also be referred to as a radio access network device, a radio access network (RAN), a radio access network function, or a radio access network unit. The access network device 12 may include a base station, a WLAN access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. Provided that a same technical effect is achieved, the base station is not limited to a specific technical vocabulary. It should be noted that in embodiments of this application, only a base station in an NR system is used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF or L-NEF), a binding support function (Binding Support Function, BSF), an application function (AF), and the like. It should be noted that in the embodiments of this application, only a core network device in the NR system is used as an example for description, and a specific type of the core network device is not limited.

A relay technology in a wireless communication system is to add one or more relay nodes between a base station and a terminal to be responsible for forwarding a wireless signal one or more times, that is, the wireless signal needs to pass through a plurality of hops to reach the terminal.

The wireless relay technology can be used not only to extend cell coverage and make up for cell coverage blind spots, but also to improve a cell capacity through spatial resource reuse. For indoor coverage, the relay technology can overcome a penetration loss and improve indoor coverage quality.

In an example of simple two-hop relay, wireless relay is to divide a base station-terminal link into two links: base station-relay station and relay station-terminal, so that a poor-quality link can be replaced with two good-quality links to obtain a higher link capacity and better coverage.

Currently, a Relay supported in LTE is a UE-to-Network relay, that is, one end of the Relay is connected to the UE, and one end of the Relay is connected to the network side. The UE connected to the Relay is referred to as remote UE.

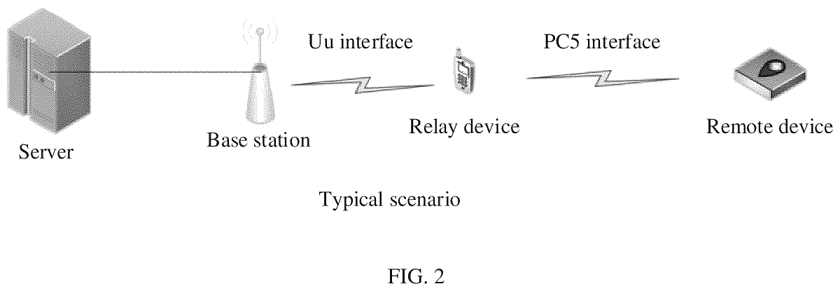

FIG. 2 shows a schematic diagram of a UE-to-Network relay scenario. In the typical UE-to-Network scenario shown in FIG. 2, Remote UE needs to perform data transmission with a network side. However, because coverage is poor, Relay UE is found as a transit of the Remote UE, where a Uu interface is between the Relay UE and a base station, and a side link interface, for example, a PC5 interface, is between the Relay UE and the Remote UE. Generally, the Relay UE is open and can serve any Remote UE.

When the PC5 interface is executed between the Remote UE and the Relay UE, that is, a sidelink operation is performed, the architecture shown in FIG. 2 may be an SL relay architecture. When another interface protocol is executed between the Remote UE and the Relay UE, for example, non-standardized UE interaction is performed in a case of ideal backhaul, or another wireless communication protocol such as wifi or Bluetooth is performed, the architecture shown in FIG. 2 is a UE relay architecture similar to the SL relay architecture.

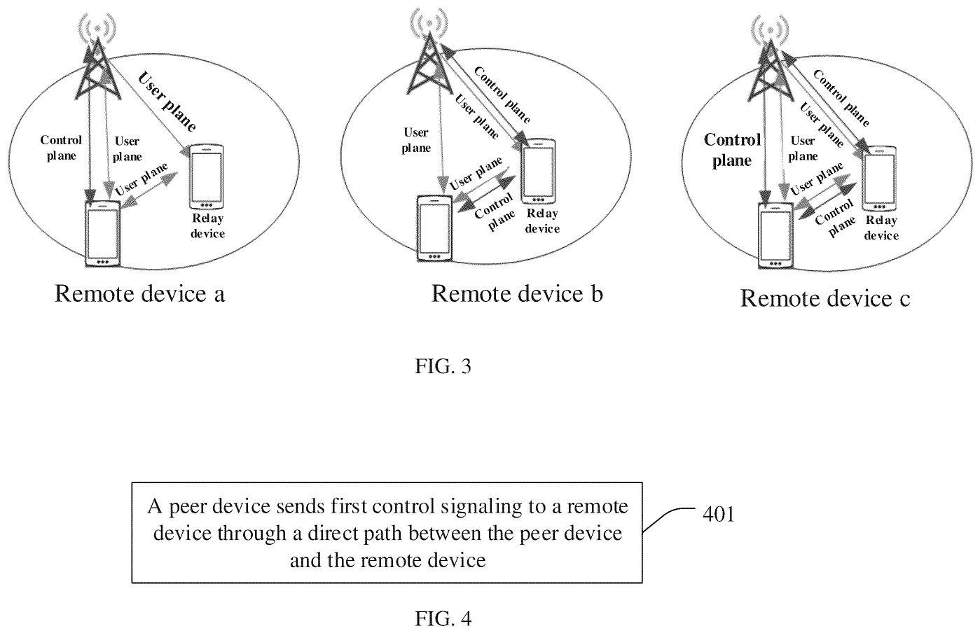

For the UE relay architecture, multi-path means that the Remote UE establishes both an indirect path and a direct path, or establishes two or more indirect paths. The indirect path is a wireless link for data transmission between the Remote UE (or Primary UE) and the base station through the Relay UE (or Secondary UE) and a Uu air interface of the Relay UE (or Secondary UE). The direct path is a wireless link for data transmission between the Remote UE (or Primary UE) and the base station through a Uu air interface of the Remote UE. FIG. 3 shows a schematic diagram of a multi-path scenario based on a UE relay architecture. As shown in FIG. 3, control plane (CP) interaction and/or user plane (UP) interaction may be performed between Remote UE and a network side device through a direct path or an indirect path of a Relay UE.

Currently, the related technologies support only single-path communication with a single-side relay or a direct link. Multi-path communication is being discussed. Therefore, there is no solution for implementing duplication transmission and path control.

According to the transmission control method provided in embodiments of this application, in a case in which a remote device (Remote UE) has a direct path and an indirect path, a target device may control, through the direct path, the remote device to perform duplication transmission and/or primary path replacement, so as to better provide a data transmission service for the Remote UE, which improves a data transmission effect of the Remote UE and reduces a delay and complexity of a control process, and further improves system efficiency on the basis of ensuring a UE service.

With reference to the accompanying drawings, the following describes in detail the transmission control method provided in embodiments of this application by using some embodiments and application scenarios thereof.

According to a first aspect, an embodiment of this application provides a data transmission method. FIG. 4 shows a flowchart of a transmission control method according to an embodiment of this application. The method is applied to a target device. As shown in FIG. 4, the method may include the following steps.

Step 401: The target device sends first control signaling to a remote device through a direct path between the target device and the remote device, where the first control signaling includes at least one of the following:
a first indication, where the first indication is used for activating or deactivating duplication transmission of a target bearer of the remote device; or
a second indication, where the second indication indicates a primary path/secondary path.

It should be noted that, in this embodiment of this application, the target device may be a network side device, or may be a terminal device. The remote device may be the terminal device 11 in FIG. 1. The remote device in this application, that is, Remote UE (or Primary UE), is used as an originating end or a receive end of data.

In this embodiment of this application, the target device sends the first control signaling to the Remote UE through the direct path, to control the Remote UE to activate or deactivate the duplication transmission, and/or to change a path. In some embodiments, the first control signaling includes medium access control layer (MAC Control Element, MAC) signaling or physical layer (Layer1, L1) signaling. The first control signaling includes the first indication and/or the second indication.

The first indication is used for activating or deactivating the duplication transmission of the target bearer of the remote device. The target bearer is a bearer that is in radio bearers of the remote device and that is configured with at least two transmission paths. In an example, the target bearer is configured with two transmission paths. Both of the two transmission paths may be direct paths; or both of the two transmission paths may be indirect paths; or one of the transmission paths may be a direct path, and the other transmission path is an indirect path. When the duplication transmission of the target bearer is in an active state, the remote device may perform duplication transmission by using the two transmission paths of the target bearer, that is, synchronously transmit a same data packet on the two transmission paths. In another example, the target bearer is configured with more than two transmission paths, including at least one direct path and at least two indirect paths. When the duplication transmission of the target bearer is in an active state, the remote device may perform duplication transmission by using transmission paths that participate in duplication transmission. For example, RB1 is configured with three transmission paths: Leg0, Leg1, and Leg2, where Leg0 is a direct path, and Leg1 and Leg2 are indirect paths. If Leg0, Leg1, and Leg2 all participate in duplication transmission, in a case in which duplication transmission of RB1 is activated, a data packet in RB1 is replicated into three copies, and the three copies are transmitted in Leg0, Leg1, and Leg2 at the same time. If only Leg0 and Leg1 participate in duplication transmission, in a case in which the duplication transmission of RB1 is activated, the data packet in RB1 is replicated into two copies, and the two copies are transmitted in Leg0 and Leg1 at the same time.

It may be understood that if the first indication is used for deactivating the duplication transmission of the target bearer of the remote device, or the duplication transmission of the remote device is in an inactive state, the target bearer uses split transmission, that is, one of the transmission paths is selected for data transmission.

The second indication indicates a primary path or a secondary path. It may be understood that the primary path mainly indicates a transmission path used when the duplication transmission of the target bearer is in the inactive state, or the split transmission of the target bearer is in an active state. Generally, when the target bearer uses split transmission, a data packet in the target bearer is transmitted by using a primary path. When a preset condition is met, for example, when an amount of to-be-sent data buffered by the target bearer is greater than a preset threshold, either of a selected transmission path that participates in split transmission and a primary path is selected for data transmission. In some embodiments, when an amount of to-be-sent data buffered by the target bearer is greater than a first threshold, either path in a primary path or a secondary path is selected for data transmission; and when a data amount of a data packet is greater than a second threshold, any one of all transmission paths (including a primary path and a secondary path) that participate in split transmission is selected for data transmission.

In some embodiments, before the target device sends the control signaling to the remote device through the direct path between the target device and the remote device, the method further includes the following step.

Step 402: The target device sends configuration information to the remote device, where the configuration information is used for configuring at least two transmission paths for the target bearer of the remote device.

In this embodiment of this application, the target device, for example, a peer-end network side device or Remote UE, may indicate, by using the configuration information, the remote device to perform initial configuration. The configuration information is mainly used for configuring the at least two transmission paths for the target bearer of the remote device. In some embodiments, the target bearer is a target bearer preconfigured by the target device, or is a target bearer specified in a protocol. The target bearer may be a Signaling Radio Bearer (SRB) and/or a data radio bearer (DRB).

If two transmission paths are configured for the target bearer, both of the two transmission paths may be direct paths; or both of the two transmission paths may be indirect paths; or one of the transmission paths may be a direct path, and the other transmission path is an indirect path. If more than two transmission paths are configured for the target bearer, generally, the at least two transmission paths include one direct path and at least two indirect paths.

In some embodiments, the configuration information includes at least one of the following:
a third indication, where the third indication indicates to configure duplication transmission for the target bearer and configure an initial state of the duplication transmission as an active state or an inactive state; or
a fourth indication, where the fourth indication indicates a primary path in the at least two transmission paths of the target bearer.

That the target device is a network side device is used as an example. In a scenario of U2N relay (UE-to-Network), the network side device may send configuration information to the Remote UE by using an RRC process, and configure two transmission paths for the target bearer of the Remote UE. One of the transmission paths is a direct path, and the other transmission path is an indirect path. The direct path is a primary path by default; or one of the two transmission paths is specified as a primary path by using the fourth indication. The network side device may configure duplication transmission for the target bearer of the Remote UE by using the third indication, and specify an initial state of the duplication transmission as an active state or an inactive state. For example, for SRB1, the network side device may configure, by using configuration information, a PDCP entity corresponding to SRB1 to be mapped to two transmission paths (RLC channels/bearers) at the same time, where one RLC channel is a direct path between the Remote UE and the network side device, and the other RLC channel is a Uu RLC channel of relay UE, and the Remote UE is reached based on an indirect path by using a mapping relationship between the Uu RLC channel and a PC5 RLC channel. A primary path of SRB1 may be the direct path by default, or is specified by the network side device by using a fourth indication. In a case in which SRB1 has two paths, the network side device may configure duplication transmission for SRB1, and an initial state is an active state by default, or an initial state of the duplication transmission of SRB1 is explicitly specified as an active state or an inactive state by using a third indication. Similarly, for a DRB, for example, data carried in the DRB has a relatively high QoS requirement or a relatively high transmission bandwidth requirement, at least two transmission paths may be configured for the DRB, and duplication transmission is configured for the DRB by using a third indication.

It may be understood that, in this embodiment of this application, if the third indication in the configuration information indicates to configure the duplication transmission for the target bearer and configure the initial state of the duplication transmission as an active state in an initial configuration phase, the target device may indicate, in a subsequent data transmission process by using the first control instruction carrying the first indication, to deactivate the duplication transmission of the target bearer. On the contrary, if the third indication in the configuration information indicates to configure the duplication transmission for the target bearer and configure the initial state of the duplication transmission as an inactive state, the target device may indicate, in a subsequent data transmission process by using the first control instruction carrying the first indication, to activate the duplication transmission of the target bearer, thereby implementing dynamic control on the duplication transmission of the remote device.

Similarly, the target device may change the primary path indicated in the fourth indication by using the first control instruction that carries the second indication.

In an optional embodiment of this application, the first indication includes a first bearer identifier and a first sequence, and the first sequence includes a duplication transmission parameter of a target bearer corresponding to the first bearer identifier. A value of the duplication transmission parameter being a first value indicates to activate duplication transmission of the target bearer corresponding to the duplication transmission parameter; or a value of the duplication transmission parameter being a second value indicates to deactivate duplication transmission of the target bearer corresponding to the duplication transmission parameter.

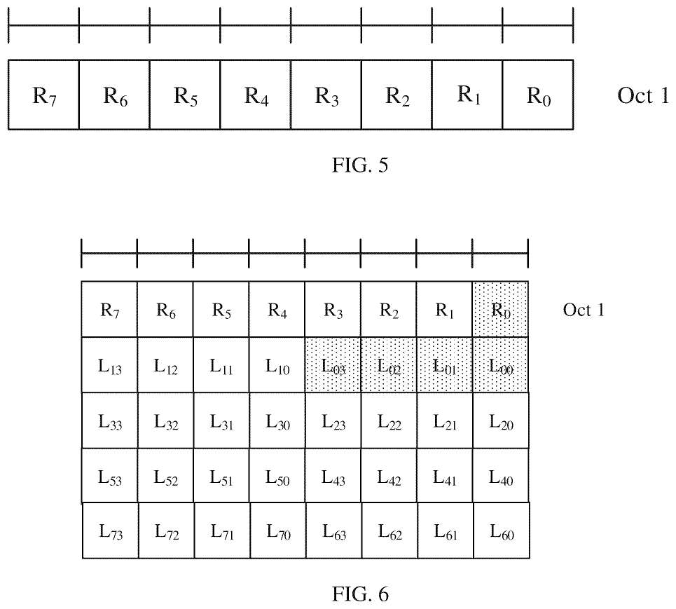

In this embodiment of this application, the target device may activate or deactivate the duplication transmission of the target bearer based on an RB granularity. In some embodiments, the first indication may include two pieces of information: the first bearer identifier and the first sequence. The first bearer identifier is an identity of the target bearer that needs to be dynamically controlled, for example, an RB ID or an RB bit. The first sequence includes the duplication transmission parameter of the target bearer corresponding to the first bearer identifier. If the value of the duplication transmission parameter is the first value, for example, 1, it indicates to activate the duplication transmission of the target bearer corresponding to the duplication transmission parameter. If the value of the duplication transmission parameter is the second value, for example, 0, it indicates to deactivate the duplication transmission of the target bearer corresponding to the duplication transmission parameter. In an example, a typical control signaling format, such as a MAC signaling format, is shown in FIG. 5. Ri represents all SRB and DRB bearers that are configured with two paths and is sorted in a sequence in configuration information. For example, SRB1, DRB0, DRB5, and DRB9 are configured with two paths, and are respectively corresponding to R0, R1, R2, and R3 in a configuration sequence. Each Ri is a binary bit, and has two values: “0” and “1”. Meanings of the values may be specified. For example, 0 represents deactivation and 1 represents activation, or vice versa. In this way, duplication transmission control can be performed at a level of each RB by using such signaling format. It may be understood that, in the first sequence, an SRB sequence is always arranged before or after a DRB sequence by default, or the SRB and the DRB are sorted according to different independent sequences.

In another optional embodiment of this application, the first indication includes a first parameter, and a value of the first parameter being a first value indicates to activate duplication transmission of all target bearers in a signaling radio bearer and/or a data radio bearer of the remote device; or
a value of the first parameter being a second value indicates to deactivate duplication transmission of all target bearers in a signaling radio bearer and/or a data radio bearer of the remote device.

In this embodiment of this application, the target device may activate or deactivate the duplication transmission of the target bearer based on a granularity of UE. In some embodiments, the first indication may include the first parameter. If the value of the first parameter is the first value, it indicates to activate duplication transmission of all the target bearers in the SRB and/or the DRB of the remote device. If the value of the first parameter is the second value, it indicates to deactivate duplication transmission of all the target bearers in the SRB and/or the DRB of the remote device. In an example, the first parameter may be 1 bit, for example, 1 or 0, indicating activation or deactivation of duplication transmission of all target bearers on which at least two transmission paths are configured in the remote device. The first parameter may be 2 bits, where one bit is used to control the SRB, and the other bit is used to control the DRB, thereby implementing independent control on the SRB and the DRB.

In some embodiments, the first indication further includes a first path identifier, and the first path identifier indicates transmission paths that are in all transmission paths of the target bearer and that participate in duplication transmission.

In this embodiment of this application, the target bearer may have two or more transmission paths. When two transmission paths are configured for the target bearer, the two paths both participate in duplication transmission. In some embodiments, when the duplication transmission of the target bearer is in an active state, the remote device may perform duplication transmission by using the two transmission paths of the target bearer.

When there are more than two transmission paths of the target bearer, for example, the target bearer is configured with more than two transmission paths, including at least one direct path and at least two indirect paths, the target device may indicate, to the remote device by using the first indication that carries the first path identifier, transmission paths that participate in duplication transmission. In this embodiment of this application, all transmission paths corresponding to the first path identifier participate in duplication transmission, that is, the target device may notify, by using the first indication, the Remote UE of a path identifier of each transmission path that participates in duplication transmission.

In some embodiments, the first indication further includes a second sequence, and the second sequence includes a second parameter corresponding to each transmission path of the target bearer. A value of the second parameter being a first value indicates that a transmission path corresponding to the second parameter participates in duplication transmission; or a value of the second parameter being a second value indicates that a transmission path corresponding to the second parameter does not participate in duplication transmission.

In this embodiment of this application, the target device may carry, in the first indication, the second parameter corresponding to each transmission path of the target bearer, and notify, by using a value of the second parameter, the Remote UE of a transmission path that participates in duplication transmission. For example, the first indication may be “RB info+Leg0 Leg1 Leg2 Leg3”, where RB info is the first bearer identifier, which may be an RB ID or an RB bit; and Leg0, Leg1, Leg2, and Leg3 are all second parameters, and each Leg (0 or 1) represents whether the transmission path participates in duplication transmission. Based on this manner, the target device may flexibly select a path combination that is in the target bearer and that participates in duplication transmission.

It may be understood that the primary path has a special status. Therefore, the primary path may be always involved in duplication transmission by default, which does not need to be indicated. The target device only needs to select, from other transmission paths except the primary path, a path that participates in duplication transmission, and notifies the Remote UE by using the first indication.

In an optional embodiment of this application, the first control instruction includes only the second indication, or the first control instruction includes the first indication, and the first indication indicates to deactivate the duplication transmission of the target bearer of the remote device. The method further includes the following step.

Step 403: The target device sends second control signaling to the remote device, where the second control signaling includes a fifth indication, and the fifth indication is used for activating or deactivating split transmission of the target bearer of the remote device.

The second control signaling may include MAC signaling or L1 signaling.

In this embodiment of this application, if the first control signaling includes only the second indication (that is, the target device does not indicate, by using the first control signaling, the Remote UE to activate or deactivate the duplication transmission), or the first indication carried in the first control signaling indicates to deactivate the duplication transmission of the target bearer of the Remote UE (that is, the duplication transmission of the target bearer of the Remote UE is currently in an inactive state), in both cases, the target device may send the second control signaling to the Remote UE, and indicate, by using the fifth indication carried in the second control signaling, the Remote UE to activate or deactivate the split transmission of the target bearer.

It may be understood that if the first indication is used for deactivating the duplication transmission of the target bearer of the remote device, or the fifth indication indicates to activate the split transmission of the target bearer, the target bearer uses split transmission, that is, one of the transmission paths is selected for data transmission.

In some embodiments, the fifth indication includes a second bearer identifier and a third sequence, and the third sequence includes a split transmission parameter of a target bearer corresponding to the second bearer identifier. A value of the split transmission parameter being a first value indicates to activate the split transmission of the target bearer; or a value of the split transmission parameter being a second value indicates to deactivate the split transmission of the target bearer.

In this embodiment of this application, the target device may activate or deactivate the split transmission of the target bearer based on a granularity of an RB. In some embodiments, the fifth indication may include two pieces of information: the second bearer identifier and the third sequence. The second bearer identifier is an identity of the target bearer that needs to be dynamically controlled, for example, an RB ID or an RB bit. The third sequence includes the split transmission parameter of the target bearer corresponding to the second bearer identifier. If the value of the split transmission parameter is the first value, for example, 1, it indicates to activate the split transmission of the target bearer corresponding to the split transmission parameter. If the value of the split transmission parameter is the second value, for example, 0, it indicates to deactivate the split transmission of the target bearer corresponding to the split transmission parameter.

It may be understood that, in the third sequence, a split transmission parameter of an SRB is always arranged before or after a split transmission parameter of a DRB, or the SRB and the DRB are sorted according to different independent sequences.

In some embodiments, the fifth indication includes a second parameter, and a value of the second parameter being a first value indicates to activate split transmission of all the target bearers in the signaling radio bearer and/or the data radio bearer of the remote device; or a value of the second parameter being a second value indicates to deactivate split transmission of all the target bearers in the signaling radio bearer and/or the data radio bearer of the remote device.

In this embodiment of this application, the target device may activate or deactivate the split transmission of the target bearer based on a granularity of UE. In some embodiments, the fifth indication may include the second parameter. If the value of the second parameter is the first value, it indicates to activate split transmission of all the target bearers in the SRB and/or the DRB of the remote device. If the value of the second parameter is the second value, it indicates to deactivate split transmission of all the target bearers in the SRB and/or the DRB of the remote device. In an example, the second parameter may be 1 bit, for example, 1 or 0, indicating activation or deactivation of split transmission of all target bearers on which at least two transmission paths are configured in the remote device. The second parameter may be 2 bits, where one bit is used to control the split transmission of the SRB, and the other bit is used to control the split transmission of the DRB, so as to implement independent control on the SRB and the DRB.

In some embodiments, the fifth indication further includes a second path identifier, and the second path identifier indicates a transmission path that is in all the transmission paths of the target bearer and that participates in split transmission.

In this embodiment of this application, one of the at least two transmission paths of the target bearer may be selected to participate in split transmission. In some embodiments, the fifth indication may carry the second path identifier, and a transmission path corresponding to the second path identifier participates in split transmission.

In some embodiments, the fifth indication further includes a fourth sequence, and the fourth sequence includes a third parameter corresponding to each transmission path corresponding to the target bearer. A value of the third parameter being a first value indicates that a transmission path corresponding to the third parameter participates in split transmission; or a value corresponding to the third parameter being a second value indicates that a transmission path corresponding to the third parameter does not participate in split transmission.

In this embodiment of this application, the target device may carry, in the fifth indication, the third parameter corresponding to each transmission path of the target bearer, and notify, by using a value of the third parameter, the Remote UE of a transmission path that participates in split transmission. For example, the fifth indication may be “RB info+Leg0 Leg1 Leg2 Leg3”, where RB info is the second bearer identifier, which may be an RB ID or an RB bit; and Leg0, Leg1, Leg2, and Leg3 are all third parameters, and each Leg (0 or 1) represents whether the transmission path participates in split transmission. Based on this manner, the target device may flexibly select a transmission path that is in the target bearer and that participates in split transmission.

It may be understood that the primary path has a special status. Therefore, the primary path may be always involved in split transmission by default, which does not need to be indicated. The target device only needs to select, from other transmission paths except the primary path, a path that participates in split transmission, and notifies the Remote UE by using the fifth indication.

Generally, when split transmission is used for the target bearer, that is, the duplication transmission of the target bearer is in an inactive state, or the split transmission of the target bearer is in an active state, a data packet in the target bearer is transmitted by using the primary path. When a preset condition is met, for example, when an amount of to-be-sent data buffered by the target bearer is greater than a preset threshold, either of a selected transmission path that participates in split transmission and a primary path is selected for data transmission. In some embodiments, when an amount of to-be-sent data buffered by the target bearer is greater than a first threshold, either path in a primary path or a secondary path is selected for data transmission; and when a data amount of a data packet is greater than a second threshold, any one of all transmission paths (including a primary path and a secondary path) that participate in split transmission is selected for data transmission.

It may be understood that at a same moment, a same target bearer can select either duplication transmission or split transmission. Therefore, the duplication transmission and the split transmission of the target bearer may be jointly controlled by using one piece of control signaling. FIG. 6 shows a typical control signaling format. As shown in FIG. 6, the Ri bits in the first row indicate an arrangement order of target bearers on which multiple paths are configured, and a value of 0 or 1 of the bit may indicate whether the target bearer uses duplication transmission (duplication activation) or split transmission (duplication deactivation/split). Then, every four L bits below correspond to one RB, for example, L00, L01, L02, and L03 correspond to statuses of four transmission paths of the target bearer R0: whether to participate in duplication transmission, whether to participate in split transmission, or the like.

In an optional embodiment of this application, the second indication includes a fifth sequence, and the fifth sequence includes a fourth parameter corresponding to each target bearer of the remote device. A value of the fourth parameter being a first value indicates that a primary path of a target bearer corresponding to the fourth parameter is a direct path; or a value of the fourth parameter being a second value indicates that a primary path of a target bearer corresponding to the fourth parameter is an indirect path.

In this embodiment of this application, the target device may update the primary path based on a granularity of an RB. In some embodiments, the second indication may include the fourth parameter corresponding to each target bearer of the Remote UE. If the value of the fourth parameter is the first value, for example, 1, it indicates that the primary path of the target bearer is a direct path. If the value of the fourth parameter is the second value, it indicates that the primary path of the target bearer is an indirect path.

It may be understood that when the target bearer has two transmission paths, one of which is a direct path, and the other is an indirect path, the target device may clearly notify, by using the fifth sequence carried in the second indication, the primary path corresponding to the target bearer of the Remote UE. When the target bearer has more than two transmission paths, especially when the target bearer has more than two indirect paths, a primary path cannot be clearly indicated by using only the fifth sequence. In this case, each transmission path needs to be separately indicated.

In another optional embodiment of this application, the second indication includes the sixth sequence, and the sixth sequence includes a fifth parameter corresponding to each transmission path of each target bearer of the remote device. A value of the fifth parameter being a first value indicates that a transmission path corresponding to the fifth parameter is a primary path of a target bearer to which the transmission path belongs; or a value of the fifth parameter being a second value indicates that a transmission path corresponding to the fifth parameter is a secondary path of a target bearer to which the transmission path belongs.

In this embodiment of this application, the target device may clearly notify, by using the sixth sequence carried in the second indication, the primary path corresponding to the target bearer of the Remote UE.

In addition, the second indication may further carry a bearer identifier, so as to notify the Remote UE of a specific target bearer on which primary path change is to be performed. For example, the second indication may be “RB index+leg index”, where the RB index is a bearer identifier sequence of a target bearer on which at least two transmission paths are configured, and the leg index is a path identifier sequence arranged according to the bearer identifier sequence. It is assumed that the Remote UE configures eight RBs in total including multi-path SRBs and multi-path DRBs, and RB indexes are 0 to 7. An RB index of each RB is determined according to a location at which the RB appears in configuration signaling, or an RB index is explicitly configured for the UE. If four transmission paths are configured for the RB, the No. 0 transmission path is the primary path by default during initial configuration. Subsequently, the target device instructs to change the primary path to No. 1 path.

It may be understood that, in the sixth sequence, a fifth parameter of an SRB is always arranged before or after a fifth parameter of a DRB by default, or the SRB and the DRB are sorted according to different independent sequences.

In some embodiments, the second indication includes a sixth parameter, and a value of the sixth parameter being a first value indicates that primary paths of all the target bearers in the signaling radio bearer and/or the data radio bearer of the remote device are direct paths; or a value of the sixth parameter being a second value indicates that primary paths of all the target bearers in the signaling radio bearer and/or the data radio bearer of the remote device are indirect paths.

The target device may further change a primary path based on a granularity of UE. In some embodiments, the second indication may include a sixth parameter. A value of the sixth parameter being a first value indicates that primary paths of all the target bearers in the SRB and/or the DRB of the remote device are direct paths. A value of the sixth parameter being the second value indicates that primary paths of all the target bearers in the SRB and/or the DRB of the remote device are indirect paths. In an example, the sixth parameter may be 1 bit, for example, 1 or 0, indicating that primary paths of all target bearers on which at least two transmission paths are configured in the remote device are direct paths or indirect paths. The second parameter may be 2 bits, where one bit is used to control the primary path of the SRB, and the other bit is used to control the primary path of the DRB, thereby implementing independent control on the SRB and the DRB.

In some embodiments, the first control signaling further includes a sixth indication, and the sixth indication indicates a function range of the first control signaling. The target bearer is a radio bearer within the function range.

It should be noted that the first control signaling/the second control signaling in this application may be MAC signaling or L1 signaling. The L1 signaling, such as physical downlink control channel (PDCCH) signaling, may generally carry a small amount of information, for example, 1 bit or several bits. Therefore, it is difficult to carry too much information by using signaling content itself. Therefore, in this embodiment of this application, duplication transmission of all the target bearers in the SRB and/or the DRB may be activated or deactivated together based on the first parameter in the foregoing first indication, or split transmission of all the target bearers in the SRB and/or the DRB may be activated or deactivated together based on the second parameter in the foregoing fifth indication.

In this embodiment of this application, a preconfiguration manner may be used. For example, a function range of the first control signaling/the second control signaling is preconfigured by the target device or pre-specified in a protocol. For example, the target device configures, by using the sixth indication, a target bearer targeted by the first control signaling. Once the first control instruction is received, the Remote UE knows the target bearer for which duplication transmission needs to be activated or deactivated, and/or a primary path needs to be changed.

In some embodiments, the function range includes a radio bearer included in a physical downlink shared channel (PDSCH)/a physical uplink shared channel (PUSCH) corresponding to a physical downlink control channel for transmitting the first control signaling.

In conclusion, this embodiment of this application provides the transmission control method. In a UE relay scenario, the target device may control, by using the first control signaling, the remote device to activate or deactivate the duplication transmission of the target bearer and/or change the primary path, so as to flexibly use each transmission path, thereby improving data transmission efficiency.

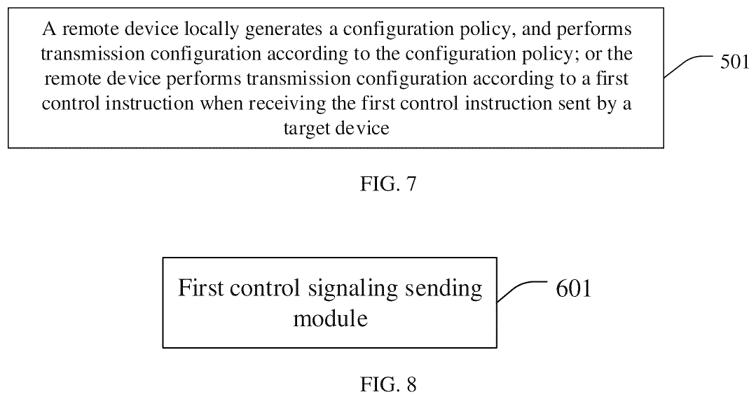

According to a second aspect, an embodiment of this application provides another transmission control method. FIG. 7 shows a flowchart of another transmission control method according to an embodiment of this application. The method is applied to a remote device. As shown in FIG. 7, the method may include the following steps.

Step 501: The remote device locally generates a configuration policy, and performs transmission configuration according to the configuration policy; or the remote device performs transmission configuration according to a first control instruction when receiving the first control instruction sent by a target device.

The configuration policy or the first control instruction includes at least one of the following:
a first indication, where the first indication is used for activating or deactivating duplication transmission of a first target bearer of the remote device; or
a second indication, where the second indication indicates a primary path or a secondary path.

It should be noted that in this embodiment of this application, the target device mainly refers to a remote device at a peer end. The remote device in this application, that is, Remote UE (or Primary UE), is used as an originating end or a receive end of data. The remote device may be the terminal device 11 in FIG. 1.

It may be understood that, in UE-to-UE communication, because the two UEs have relatively equal positions, the Remote UE may determine a configuration policy by itself, or the target device controls, by using first control signaling, the Remote UE to activate or deactivate the duplication transmission of the target bearer and/or change the primary path. In UE-to-Network communication, a network side device generally controls, by using first control signaling, the Remote UE to activate or deactivate the duplication transmission of the target bearer and/or change the primary path.

For specific content of the first indication and the second indication, refer to the foregoing related description of the first aspect. Details are not further described in this embodiment of this application.

In some embodiments, in a case in which the remote device receives the first control instruction sent by the target device, before the performing transmission configuration according to the first control instruction, the method further includes:
the remote device receives configuration information sent by the target device, and performs initialization configuration based on the configuration information, where the configuration information is used to configure at least two transmission paths for a target bearer of the remote device.

In some embodiments, the configuration information includes at least one of the following:
a third indication, where the third indication indicates to configure duplication transmission for the target bearer and configure an initial state of the duplication transmission as an active state or an inactive state; or
a fourth indication, where the fourth indication indicates a primary path in the at least two transmission paths of the target bearer.

In some embodiments, the first indication includes a first bearer identifier and a first sequence, and the first sequence includes a duplication transmission parameter of a target bearer corresponding to the first bearer identifier.

A value of the duplication transmission parameter being a first value indicates to activate duplication transmission of the target bearer corresponding to the duplication transmission parameter; or
a value of the duplication transmission parameter being a second value indicates to deactivate duplication transmission of the target bearer corresponding to the duplication transmission parameter.

In some embodiments, the first indication includes a first parameter, and a value of the first parameter being a first value indicates to activate duplication transmission of all target bearers in a signaling radio bearer and/or a data radio bearer of the remote device; or
a value of the first parameter being a second value indicates to deactivate duplication transmission of all target bearers in a signaling radio bearer and/or a data radio bearer of the remote device.

In some embodiments, the first indication further includes a first path identifier, and the first path identifier indicates transmission paths that are in all transmission paths of the target bearer and that participate in duplication transmission.

In some embodiments, the first indication further includes a second sequence, and the second sequence includes a second parameter corresponding to each transmission path of the target bearer.

A value of the second parameter being a first value indicates that a transmission path corresponding to the second parameter participates in duplication transmission; or
a value of the second parameter being a second value indicates that a transmission path corresponding to the second parameter does not participate in duplication transmission.

In some embodiments, the first control instruction includes only the second indication, or the first control instruction includes the first indication, and the first indication indicates to deactivate the duplication transmission of the target bearer of the remote device. The method further includes the following step.

The remote device receives second control signaling sent by the target device, and performs transmission configuration based on the second control signaling, where the second control signaling includes a fifth indication, and the fifth indication is used for activating or deactivating split transmission of the target bearer of the remote device.

In some embodiments, the fifth indication includes a second bearer identifier and a third sequence, and the third sequence includes a split transmission parameter of a target bearer corresponding to the second bearer identifier.

A value of the split transmission parameter being a first value indicates to activate split transmission of the target bearer; or
a value of the split transmission parameter being a second value indicates to deactivate split transmission of the target bearer.

In some embodiments, the fifth indication includes a second parameter, and a value of the second parameter being a first value indicates to activate split transmission of all the target bearers in the signaling radio bearer and/or the data radio bearer of the remote device; or
a value of the second parameter being a second value indicates to deactivate split transmission of all the target bearers in the signaling radio bearer and/or the data radio bearer of the remote device.

In some embodiments, the fifth indication further includes a second path identifier, and the second path identifier indicates a transmission path that is in all the transmission paths of the target bearer and that participates in split transmission.

In some embodiments, the fifth indication further includes a fourth sequence, and the fourth sequence includes a third parameter corresponding to each transmission path corresponding to the target bearer.

A value of the third parameter being a first value indicates that a transmission path corresponding to the third parameter participates in split transmission; or
a value corresponding to the third parameter being a second value indicates that a transmission path corresponding to the third parameter does not participate in split transmission.

In some embodiments, the second indication includes a fifth sequence, and the fifth sequence includes a fourth parameter corresponding to each target bearer of the remote device.

A value of the fourth parameter being a first value indicates that a primary path of a target bearer corresponding to the fourth parameter is a direct path; or
a value of the fourth parameter being a second value indicates that a primary path of a target bearer corresponding to the fourth parameter is an indirect path.

In some embodiments, the second indication includes the sixth sequence, and the sixth sequence includes a fifth parameter corresponding to each transmission path of each target bearer of the remote device.

A value of the fifth parameter being a first value indicates that a transmission path corresponding to the fifth parameter is a primary path of a target bearer to which the transmission path belongs; or
a value of the fifth parameter being a second value indicates that a transmission path corresponding to the fifth parameter is a secondary path of a target bearer to which the transmission path belongs.

In some embodiments, the second indication includes a sixth parameter, and a value of the sixth parameter being a first value indicates that primary paths of all the target bearers in the signaling radio bearer and/or the data radio bearer of the remote device are direct paths; or
a value of the sixth parameter being a second value indicates that primary paths of all the target bearers in the signaling radio bearer and/or the data radio bearer of the remote device are indirect paths.

In some embodiments, in at least one of the first indication, the second indication, or the fifth indication, a parameter corresponding to the signaling radio bearer is arranged before a parameter corresponding to the data radio bearer; or in at least one of the first indication, the second indication, or the fifth indication, a parameter corresponding to the signaling radio bearer and a parameter corresponding to the data radio bearer are arranged independently.

In some embodiments, the first control signaling/the second control signaling includes medium access control layer signaling or physical layer signaling.

In some embodiments, the target bearer is a target bearer preconfigured by the target device, or is a target bearer specified in a protocol.

In some embodiments, the first control signaling further includes a sixth indication, and the sixth indication indicates a function range of the first control signaling. The target bearer is a radio bearer within the function range.

In some embodiments, the function range includes a radio bearer included in a physical downlink shared channel/a physical uplink shared channel corresponding to a physical downlink control channel for transmitting the first control signaling.

In some embodiments, the at least two transmission paths include one direct path and at least two indirect paths.

For specific content of the foregoing optional embodiments, refer to related descriptions of the foregoing first aspect. Details are not further described in this embodiment of this application.

The transmission control method provided in embodiments of this application may be executed by a transmission control apparatus. In embodiments of this application, the transmission control apparatus provided in embodiments of this application is described by using an example in which the transmission control apparatus executes the transmission control method.

According to a third aspect, an embodiment of this application provides a transmission control apparatus. FIG. 8 shows a block diagram of a structure of a transmission control apparatus according to an embodiment of this application. The apparatus may be applied to a target device. As shown in FIG. 8, the apparatus may include:
a first control signaling sending module 601, configured to send first control signaling to a remote device through a direct path to the remote device, where the first control signaling includes at least one of the following:
a first indication, where the first indication is used for activating or deactivating duplication transmission of a target bearer of the remote device; or
a second indication, where the second indication indicates a primary path/secondary path.

In some embodiments, the apparatus further includes:
a configuration information sending module, configured to send configuration information to the remote device, where the configuration information is used for configuring at least two transmission paths for the target bearer of the remote device.

In some embodiments, the configuration information includes at least one of the following:
a third indication, where the third indication indicates to configure duplication transmission for the target bearer and configure an initial state of the duplication transmission as an active state or an inactive state; or
a fourth indication, where the fourth indication indicates a primary path in the at least two transmission paths of the target bearer.

In some embodiments, the first indication includes a first bearer identifier and a first sequence, and the first sequence includes a duplication transmission parameter of a target bearer corresponding to the first bearer identifier.

A value of the duplication transmission parameter being a first value indicates to activate duplication transmission of the target bearer corresponding to the duplication transmission parameter; or
a value of the duplication transmission parameter being a second value indicates to deactivate duplication transmission of the target bearer corresponding to the duplication transmission parameter.

In some embodiments, the first indication includes a first parameter, and a value of the first parameter being a first value indicates to activate duplication transmission of all target bearers in a signaling radio bearer and/or a data radio bearer of the remote device; or
a value of the first parameter being a second value indicates to deactivate duplication transmission of all target bearers in a signaling radio bearer and/or a data radio bearer of the remote device.

In some embodiments, the first indication further includes a first path identifier, and the first path identifier indicates transmission paths that are in all transmission paths of the target bearer and that participate in duplication transmission.

In some embodiments, the first indication further includes a second sequence, and the second sequence includes a second parameter corresponding to each transmission path of the target bearer.

A value of the second parameter being a first value indicates that a transmission path corresponding to the second parameter participates in duplication transmission; or
a value of the second parameter being a second value indicates that a transmission path corresponding to the second parameter does not participate in duplication transmission.

In some embodiments, the first control instruction includes only the second indication, or the first control instruction includes the first indication, and the first indication indicates to deactivate the duplication transmission of the target bearer of the remote device. The apparatus further includes:
a second control signaling sending module, configured to send second control signaling to the remote device, where the second control signaling includes a fifth indication, and the fifth indication is used for activating or deactivating split transmission of the target bearer of the remote device.

In some embodiments, the fifth indication includes a second bearer identifier and a third sequence, and the third sequence includes a split transmission parameter of a target bearer corresponding to the second bearer identifier.

A value of the split transmission parameter being a first value indicates to activate split transmission of the target bearer; or
a value of the split transmission parameter being a second value indicates to deactivate split transmission of the target bearer.

In some embodiments, the fifth indication includes a second parameter, and a value of the second parameter being a first value indicates to activate split transmission of all the target bearers in the signaling radio bearer and/or the data radio bearer of the remote device; or
a value of the second parameter being a second value indicates to deactivate split transmission of all the target bearers in the signaling radio bearer and/or the data radio bearer of the remote device.

In some embodiments, the fifth indication further includes a second path identifier, and the second path identifier indicates a transmission path that is in all the transmission paths of the target bearer and that participates in split transmission.

In some embodiments, the fifth indication further includes a fourth sequence, and the fourth sequence includes a third parameter corresponding to each transmission path corresponding to the target bearer.

A value of the third parameter being a first value indicates that a transmission path corresponding to the third parameter participates in split transmission; or
a value corresponding to the third parameter being a second value indicates that a transmission path corresponding to the third parameter does not participate in split transmission.

In some embodiments, the second indication includes a fifth sequence, and the fifth sequence includes a fourth parameter corresponding to each target bearer of the remote device.

A value of the fourth parameter being a first value indicates that a primary path of a target bearer corresponding to the fourth parameter is a direct path; or
a value of the fourth parameter being a second value indicates that a primary path of a target bearer corresponding to the fourth parameter is an indirect path.

In some embodiments, the second indication includes the sixth sequence, and the sixth sequence includes a fifth parameter corresponding to each transmission path of each target bearer of the remote device.

A value of the fifth parameter being a first value indicates that a transmission path corresponding to the fifth parameter is a primary path of a target bearer to which the transmission path belongs; or
a value of the fifth parameter being a second value indicates that a transmission path corresponding to the fifth parameter is a secondary path of a target bearer to which the transmission path belongs.

In some embodiments, the second indication includes a sixth parameter. A value of the sixth parameter being a first value indicates that primary paths of all the target bearers in the signaling radio bearer and/or the data radio bearer of the remote device are direct paths; or
a value of the sixth parameter being a second value indicates that primary paths of all the target bearers in the signaling radio bearer and/or the data radio bearer of the remote device are indirect paths.

In some embodiments, in at least one of the first indication, the second indication, or the fifth indication, a parameter corresponding to the signaling radio bearer is arranged before a parameter corresponding to the data radio bearer; or in at least one of the first indication, the second indication, or the fifth indication, a parameter corresponding to the signaling radio bearer and a parameter corresponding to the data radio bearer are arranged independently.

In some embodiments, the first control signaling/the second control signaling includes medium access control layer signaling or physical layer signaling.

In some embodiments, the target bearer is a target bearer preconfigured by the target device, or is a target bearer specified in a protocol.

In some embodiments, the first control signaling further includes a sixth indication, and the sixth indication indicates a function range of the first control signaling. The target bearer is a radio bearer within the function range.

In some embodiments, the function range includes a radio bearer included in a physical downlink shared channel/a physical uplink shared channel corresponding to a physical downlink control channel for transmitting the first control signaling.

In some embodiments, the at least two transmission paths include one direct path and at least two indirect paths.

In some embodiments, the target device includes a network side device or a terminal device.

The transmission control apparatus provided in this embodiment of this application can implement processes implemented in the method embodiment in the first aspect, and achieve same technical effects. To avoid repetition, details are not described herein again.

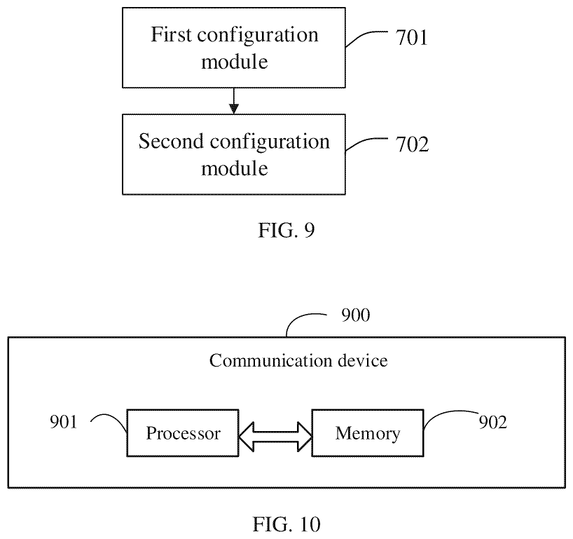

According to a fourth aspect, an embodiment of this application provides another transmission control apparatus. FIG. 9 shows a block diagram of a structure of a transmission control apparatus according to an embodiment of this application. The apparatus may be applied to a remote device. As shown in FIG. 9, the apparatus may include:
a first configuration module 701, configured to locally generate a configuration policy, and perform transmission configuration according to the configuration policy; or
a second configuration module 702, configured to perform transmission configuration according to a first control instruction when receiving the first control instruction sent by a target device.

The configuration policy or the first control instruction includes at least one of the following:
a first indication, where the first indication is used for activating or deactivating duplication transmission of a first target bearer of the remote device; or
a second indication, where the second indication indicates a primary path/secondary path.

In some embodiments, the apparatus further includes:
an initial configuration module, configured to: receive configuration information sent by the target device, and perform initialization configuration based on the configuration information, where the configuration information is used to configure at least two transmission paths for a target bearer of the remote device.

In some embodiments, the configuration information includes at least one of the following:
a third indication, where the third indication indicates to configure duplication transmission for the target bearer and configure an initial state of the duplication transmission as an active state or an inactive state; or
a fourth indication, where the fourth indication indicates a primary path in the at least two transmission paths of the target bearer.

In some embodiments, the first indication includes a first bearer identifier and a first sequence, and the first sequence includes a duplication transmission parameter of a target bearer corresponding to the first bearer identifier.

A value of the duplication transmission parameter being a first value indicates to activate duplication transmission of the target bearer corresponding to the duplication transmission parameter; or
a value of the duplication transmission parameter being a second value indicates to deactivate duplication transmission of the target bearer corresponding to the duplication transmission parameter.

In some embodiments, the first indication includes a first parameter, and a value of the first parameter being a first value indicates to activate duplication transmission of all target bearers in a signaling radio bearer and/or a data radio bearer of the remote device; or
a value of the first parameter being a second value indicates to deactivate duplication transmission of all target bearers in a signaling radio bearer and/or a data radio bearer of the remote device.

In some embodiments, the first indication further includes a first path identifier, and the first path identifier indicates transmission paths that are in all transmission paths of the target bearer and that participate in duplication transmission.

In some embodiments, the first indication further includes a second sequence, and the second sequence includes a second parameter corresponding to each transmission path of the target bearer.

A value of the second parameter being a first value indicates that a transmission path corresponding to the second parameter participates in duplication transmission; or
a value of the second parameter being a second value indicates that a transmission path corresponding to the second parameter does not participate in duplication transmission.

In some embodiments, the first control instruction includes only the second indication, or the first control instruction includes the first indication, and the first indication indicates to deactivate the duplication transmission of the target bearer of the remote device. The apparatus further includes:
a third configuration module, configured to: receive second control signaling sent by the target device, and perform transmission configuration based on the second control signaling, where the second control signaling includes a fifth indication, and the fifth indication is used for activating or deactivating split transmission of the target bearer of the remote device.

In some embodiments, the fifth indication includes a second bearer identifier and a third sequence, and the third sequence includes a split transmission parameter of a target bearer corresponding to the second bearer identifier.

A value of the split transmission parameter being a first value indicates to activate split transmission of the target bearer; or
a value of the split transmission parameter being a second value indicates to deactivate split transmission of the target bearer.

In some embodiments, the fifth indication includes a second parameter, and a value of the second parameter being a first value indicates to activate split transmission of all the target bearers in the signaling radio bearer and/or the data radio bearer of the remote device; or
a value of the second parameter being a second value indicates to deactivate split transmission of all the target bearers in the signaling radio bearer and/or the data radio bearer of the remote device.

In some embodiments, the fifth indication further includes a second path identifier, and the second path identifier indicates a transmission path that is in all the transmission paths of the target bearer and that participates in split transmission.

In some embodiments, the fifth indication further includes a fourth sequence, and the fourth sequence includes a third parameter corresponding to each transmission path corresponding to the target bearer.

A value of the third parameter being a first value indicates that a transmission path corresponding to the third parameter participates in split transmission; or
a value corresponding to the third parameter being a second value indicates that a transmission path corresponding to the third parameter does not participate in split transmission.

In some embodiments, the second indication includes a fifth sequence, and the fifth sequence includes a fourth parameter corresponding to each target bearer of the remote device.

A value of the fourth parameter being a first value indicates that a primary path of a target bearer corresponding to the fourth parameter is a direct path; or
a value of the fourth parameter being a second value indicates that a primary path of a target bearer corresponding to the fourth parameter is an indirect path.

In some embodiments, the second indication includes the sixth sequence, and the sixth sequence includes a fifth parameter corresponding to each transmission path of each target bearer of the remote device.

A value of the fifth parameter being a first value indicates that a transmission path corresponding to the fifth parameter is a primary path of a target bearer to which the transmission path belongs; or
a value of the fifth parameter being a second value indicates that a transmission path corresponding to the fifth parameter is a secondary path of a target bearer to which the transmission path belongs.

In some embodiments, the second indication includes a sixth parameter, and a value of the sixth parameter being a first value indicates that primary paths of all the target bearers in the signaling radio bearer and/or the data radio bearer of the remote device are direct paths; or
a value of the sixth parameter being a second value indicates that primary paths of all the target bearers in the signaling radio bearer and/or the data radio bearer of the remote device are indirect paths.

In some embodiments, in at least one of the first indication, the second indication, or the fifth indication, a parameter corresponding to the signaling radio bearer is arranged before a parameter corresponding to the data radio bearer; or in at least one of the first indication, the second indication, or the fifth indication, a parameter corresponding to the signaling radio bearer and a parameter corresponding to the data radio bearer are arranged independently.

In some embodiments, the first control signaling/the second control signaling includes medium access control layer signaling or physical layer signaling.

In some embodiments, the target bearer is a target bearer preconfigured by the target device, or is a target bearer specified in a protocol.

In some embodiments, the first control signaling further includes a sixth indication, and the sixth indication indicates a function range of the first control signaling. The target bearer is a radio bearer within the function range.

In some embodiments, the function range includes a radio bearer included in a physical downlink shared channel/a physical uplink shared channel corresponding to a physical downlink control channel for transmitting the first control signaling.

In some embodiments, the at least two transmission paths include one direct path and at least two indirect paths.

For specific content of the foregoing optional embodiments, refer to related descriptions of the foregoing first aspect. Details are not further described in this embodiment of this application.

The transmission control apparatus in embodiments of this application may be an electronic device, for example, an electronic device with an operating system; or may be a component in an electronic device, for example, an integrated circuit or a chip. The electronic device may be a terminal device. For example, the terminal device may include but is not limited to the foregoing listed terminal device 11.

The transmission control apparatus provided in this embodiment of this application can implement processes implemented in the method embodiment in the second aspect, and achieve same technical effects. To avoid repetition, details are not described herein again.

As shown in FIG. 10, an embodiment of this application further provides a communication device 900, including a processor 901 and a memory 902. The memory 902 stores a program or instructions that can be run on the processor 901. For example, when the communication device 900 is a network side device, the steps of the foregoing transmission control method embodiment in the first aspect are implemented when the program or the instructions are executed by the processor 901, and the same technical effects can be achieved. When the communication device 900 is a terminal device, the steps of the foregoing transmission control method embodiment in the second aspect are implemented when the program or the instructions are executed by the processor 901, and the same technical effects can be achieved. To avoid repetition, details are not described herein again.

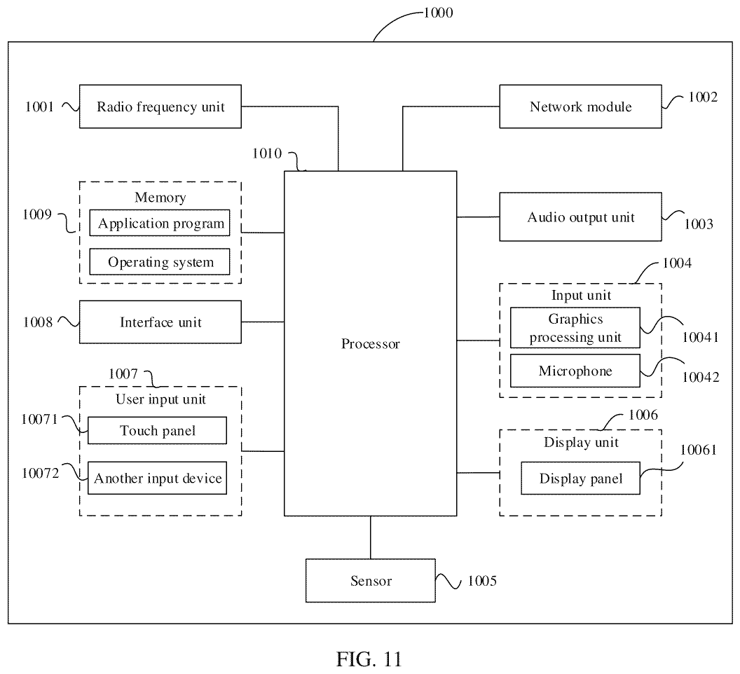

FIG. 11 is a schematic diagram of a hardware structure of a terminal device according to an embodiment of this application.

The terminal device 1000 includes but is not limited to at least a part of components of a radio frequency unit 1001, a network module 1002, an audio output unit 1003, an input unit 1004, a sensor 1005, a display unit 1006, a user input unit 1007, an interface unit 1008, a memory 1009, a processor 1010, and the like.

A person skilled in the art may understand that the terminal device 1000 may further include a power supply (for example, a battery) that supplies power to each component. The power supply may be logically connected to the processor 1010 by using a power management system, to implement functions such as charging management, discharging management, and power consumption management through the power management system. The structure of the terminal device shown in FIG. 11 does not constitute a limitation on the terminal device. The terminal device may include more or fewer components than those shown in the figure, or combine some components, or have different component arrangements. Details are not described herein again.

It should be understood that in this embodiment of this application, the input unit 1004 may include a graphics processing unit (GPU) 10041 and a microphone 10042. The graphics processing unit 10041 processes image data of a still picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 or another input device 10072. The touch panel 10071 is also referred to as a touchscreen. The touch panel 10071 may include two parts: a touch detection apparatus and a touch controller. The another input device 10072 may include but is not limited to a physical keyboard, a function key (such as a volume control key or an on/off key), a trackball, a mouse, and an operating lever. Details are not described herein again.

In this embodiment of this application, after receiving downlink data from a network side device, the radio frequency unit 1001 may transmit the downlink data to the processor 1010 for processing. In addition, the radio frequency unit 1001 may send uplink data to a network side device. Generally, the radio frequency unit 1001 includes but is not limited to an antenna, an amplifier, a transceiver, a coupler, a low-noise amplifier, a duplexer, and the like.

The memory 1009 may be configured to store a software program or instructions and various types of data. The memory 1009 may mainly include a first storage area for storing a program or instructions and a second storage area for storing data. The first storage area may store an operating system, an application program or instructions required by at least one function (for example, a sound play function or an image play function), and the like. In addition, the memory 1009 may include a volatile memory or a non-volatile memory, or the memory 1009 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1009 in this embodiment of this application includes but is not limited to these memories and any other suitable type of memory.

The processor 1010 may include one or more processing units. In some embodiments, the processor 1010 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1010.

In a scenario of this application, the radio frequency unit 1001 is configured to send first control signaling to the remote device through a direct path to the remote device, where the first control signaling includes at least one of the following:
a first indication, where the first indication is used for activating or deactivating duplication transmission of a target bearer of the remote device; or
a second indication, where the second indication indicates a primary path/secondary path.

In some embodiments, the radio frequency unit 1001 is further configured to send configuration information to the remote device, where the configuration information is used for configuring at least two transmission paths for the target bearer of the remote device.

In some embodiments, the configuration information includes at least one of the following:
a third indication, where the third indication indicates to configure duplication transmission for the target bearer and configure an initial state of the duplication transmission as an active state or an inactive state; or
a fourth indication, where the fourth indication indicates a primary path in the at least two transmission paths of the target bearer.

In some embodiments, the first indication includes a first bearer identifier and a first sequence, and the first sequence includes a duplication transmission parameter of a target bearer corresponding to the first bearer identifier.

A value of the duplication transmission parameter being a first value indicates to activate duplication transmission of the target bearer corresponding to the duplication transmission parameter; or
a value of the duplication transmission parameter being a second value indicates to deactivate duplication transmission of the target bearer corresponding to the duplication transmission parameter.

In some embodiments, the first indication includes a first parameter, and a value of the first parameter being a first value indicates to activate duplication transmission of all target bearers in a signaling radio bearer and/or a data radio bearer of the remote device; or
a value of the first parameter being a second value indicates to deactivate duplication transmission of all target bearers in a signaling radio bearer and/or a data radio bearer of the remote device.

In some embodiments, the first indication further includes a first path identifier, and the first path identifier indicates transmission paths that are in all transmission paths of the target bearer and that participate in duplication transmission.

In some embodiments, the first indication further includes a second sequence, and the second sequence includes a second parameter corresponding to each transmission path of the target bearer.

A value of the second parameter being a first value indicates that a transmission path corresponding to the second parameter participates in duplication transmission; or
a value of the second parameter being a second value indicates that a transmission path corresponding to the second parameter does not participate in duplication transmission.

In some embodiments, the first control instruction includes only the second indication, or the first control instruction includes the first indication, and the first indication indicates to deactivate the duplication transmission of the target bearer of the remote device. The radio frequency unit 1001 is further configured to send second control signaling to the remote device, where the second control signaling includes a fifth indication, and the fifth indication is used for activating or deactivating split transmission of the target bearer of the remote device.

In some embodiments, the fifth indication includes a second bearer identifier and a third sequence, and the third sequence includes a split transmission parameter of a target bearer corresponding to the second bearer identifier.

A value of the split transmission parameter being a first value indicates to activate split transmission of the target bearer; or
a value of the split transmission parameter being a second value indicates to deactivate split transmission of the target bearer.

In some embodiments, the fifth indication includes a second parameter, and a value of the second parameter being a first value indicates to activate split transmission of all the target bearers in the signaling radio bearer and/or the data radio bearer of the remote device; or
a value of the second parameter being a second value indicates to deactivate split transmission of all the target bearers in the signaling radio bearer and/or the data radio bearer of the remote device.

In some embodiments, the fifth indication further includes a second path identifier, and the second path identifier indicates a transmission path that is in all the transmission paths of the target bearer and that participates in split transmission.

In some embodiments, the fifth indication further includes a fourth sequence, and the fourth sequence includes a third parameter corresponding to each transmission path corresponding to the target bearer.

A value of the third parameter being a first value indicates that a transmission path corresponding to the third parameter participates in split transmission; or
a value corresponding to the third parameter being a second value indicates that a transmission path corresponding to the third parameter does not participate in split transmission.

In some embodiments, the second indication includes a fifth sequence, and the fifth sequence includes a fourth parameter corresponding to each target bearer of the remote device.

A value of the fourth parameter being a first value indicates that a primary path of a target bearer corresponding to the fourth parameter is a direct path; or
a value of the fourth parameter being a second value indicates that a primary path of a target bearer corresponding to the fourth parameter is an indirect path.

In some embodiments, the second indication includes the sixth sequence, and the sixth sequence includes a fifth parameter corresponding to each transmission path of each target bearer of the remote device.

A value of the fifth parameter being a first value indicates that a transmission path corresponding to the fifth parameter is a primary path of a target bearer to which the transmission path belongs; or
a value of the fifth parameter being a second value indicates that a transmission path corresponding to the fifth parameter is a secondary path of a target bearer to which the transmission path belongs.

In some embodiments, the second indication includes a sixth parameter, and a value of the sixth parameter being a first value indicates that primary paths of all the target bearers in the signaling radio bearer and/or the data radio bearer of the remote device are direct paths; or
a value of the sixth parameter being a second value indicates that primary paths of all the target bearers in the signaling radio bearer and/or the data radio bearer of the remote device are indirect paths.

In some embodiments, in at least one of the first indication, the second indication, or the fifth indication, a parameter corresponding to the signaling radio bearer is arranged before a parameter corresponding to the data radio bearer; or in at least one of the first indication, the second indication, or the fifth indication, a parameter corresponding to the signaling radio bearer and a parameter corresponding to the data radio bearer are arranged independently.

In some embodiments, the first control signaling/the second control signaling includes medium access control layer signaling or physical layer signaling.

In some embodiments, the target bearer is a target bearer preconfigured by the target device, or is a target bearer specified in a protocol.

In some embodiments, the first control signaling further includes a sixth indication, and the sixth indication indicates a function range of the first control signaling. The target bearer is a radio bearer within the function range.

In some embodiments, the function range includes a radio bearer included in a physical downlink shared channel/a physical uplink shared channel corresponding to a physical downlink control channel for transmitting the first control signaling.

In some embodiments, the at least two transmission paths include one direct path and at least two indirect paths.

In another scenario of this application, the processor 1010 is configured to: generate a configuration policy, and perform transmission configuration according to the configuration policy; or
the processor 1010 is configured to perform transmission configuration according to a control instruction when receiving the control instruction sent by a target device; where
the configuration policy or the control instruction includes at least one of the following:
a first indication, where the first indication is used for activating or deactivating duplication transmission of a first target bearer of the remote device; or
a second indication, where the second indication indicates a primary path/secondary path.

In some embodiments, the processor 1010 is further configured to receive configuration information sent by the target device, and the radio frequency unit 1001 is further configured to perform initialization configuration based on the configuration information. The configuration information is used for configuring at least two transmission paths for the target bearer of the remote device.

In some embodiments, the configuration information includes at least one of the following:
a third indication, where the third indication indicates to configure duplication transmission for the target bearer and configure an initial state of the duplication transmission as an active state or an inactive state; and
a fourth indication, where the fourth indication indicates a primary path in the at least two transmission paths of the target bearer.

In some embodiments, the first indication includes a first bearer identifier and a first sequence, and the first sequence includes a duplication transmission parameter of a target bearer corresponding to the first bearer identifier.

A value of the duplication transmission parameter being a first value indicates to activate duplication transmission of the target bearer corresponding to the duplication transmission parameter; or
a value of the duplication transmission parameter being a second value indicates to deactivate duplication transmission of the target bearer corresponding to the duplication transmission parameter.

In some embodiments, the first indication includes a first parameter, and a value of the first parameter being a first value indicates to activate duplication transmission of all target bearers in a signaling radio bearer and/or a data radio bearer of the remote device; or
a value of the first parameter being a second value indicates to deactivate duplication transmission of all target bearers in a signaling radio bearer and/or a data radio bearer of the remote device.
In some embodiments, the first indication further includes a first path identifier, and the first path identifier indicates transmission paths that are in all transmission paths of the target bearer and that participate in duplication transmission.

In some embodiments, the first indication further includes a second sequence, and the second sequence includes a second parameter corresponding to each transmission path of the target bearer.

A value of the second parameter being a first value indicates that a transmission path corresponding to the second parameter participates in duplication transmission; or
a value of the second parameter being a second value indicates that a transmission path corresponding to the second parameter does not participate in duplication transmission.

In some embodiments, the first control instruction includes only the second indication, or the first control instruction includes the first indication, and the first indication indicates to deactivate the duplication transmission of the target bearer of the remote device. The processor 1010 is further configured to receive second control signaling sent by the target device, and the radio frequency unit 1001 is further configured to perform transmission configuration according to the second control signaling. The second control signaling includes a fifth indication, and the fifth indication is used for activating or deactivating split transmission of the target bearer of the remote device.

In some embodiments, the fifth indication includes a second bearer identifier and a third sequence, and the third sequence includes a split transmission parameter of a target bearer corresponding to the second bearer identifier.

A value of the split transmission parameter being a first value indicates to activate split transmission of the target bearer; or
a value of the split transmission parameter being a second value indicates to deactivate split transmission of the target bearer.

In some embodiments, the fifth indication includes a second parameter, and a value of the second parameter being a first value indicates to activate split transmission of all the target bearers in the signaling radio bearer and/or the data radio bearer of the remote device; or
a value of the second parameter being a second value indicates to deactivate split transmission of all the target bearers in the signaling radio bearer and/or the data radio bearer of the remote device.

In some embodiments, the fifth indication further includes a second path identifier, and the second path identifier indicates a transmission path that is in all the transmission paths of the target bearer and that participates in split transmission.

In some embodiments, the fifth indication further includes a fourth sequence, and the fourth sequence includes a third parameter corresponding to each transmission path corresponding to the target bearer.

A value of the third parameter being a first value indicates that a transmission path corresponding to the third parameter participates in split transmission; or
a value corresponding to the third parameter being a second value indicates that a transmission path corresponding to the third parameter does not participate in split transmission.

In some embodiments, the second indication includes a fifth sequence, and the fifth sequence includes a fourth parameter corresponding to each target bearer of the remote device.

A value of the fourth parameter being a first value indicates that a primary path of a target bearer corresponding to the fourth parameter is a direct path; or
a value of the fourth parameter being a second value indicates that a primary path of a target bearer corresponding to the fourth parameter is an indirect path.

In some embodiments, the second indication includes the sixth sequence, and the sixth sequence includes a fifth parameter corresponding to each transmission path of each target bearer of the remote device.

A value of the fifth parameter being a first value indicates that a transmission path corresponding to the fifth parameter is a primary path of a target bearer to which the transmission path belongs; or
a value of the fifth parameter being a second value indicates that a transmission path corresponding to the fifth parameter is a secondary path of a target bearer to which the transmission path belongs.

In some embodiments, the second indication includes a sixth parameter, and a value of the sixth parameter being a first value indicates that primary paths of all the target bearers in the signaling radio bearer and/or the data radio bearer of the remote device are direct paths; or
a value of the sixth parameter being a second value indicates that primary paths of all the target bearers in the signaling radio bearer and/or the data radio bearer of the remote device are indirect paths.

In some embodiments, in at least one of the first indication, the second indication, and the fifth indication, a parameter corresponding to the signaling radio bearer is arranged before a parameter corresponding to the data radio bearer; or in at least one of the first indication, the second indication, and the fifth indication, a parameter corresponding to the signaling radio bearer and a parameter corresponding to the data radio bearer are arranged independently.

In some embodiments, the first control signaling/the second control signaling includes medium access control layer signaling or physical layer signaling.

In some embodiments, the target bearer is a target bearer preconfigured by the target device, or is a target bearer specified in a protocol.

In some embodiments, the first control signaling further includes a sixth indication, and the sixth indication indicates a function range of the first control signaling. The target bearer is a radio bearer within the function range.

In some embodiments, the function range includes a radio bearer included in a physical downlink shared channel/a physical uplink shared channel corresponding to a physical downlink control channel for transmitting the first control signaling.

In some embodiments, the at least two transmission paths include one direct path and at least two indirect paths.

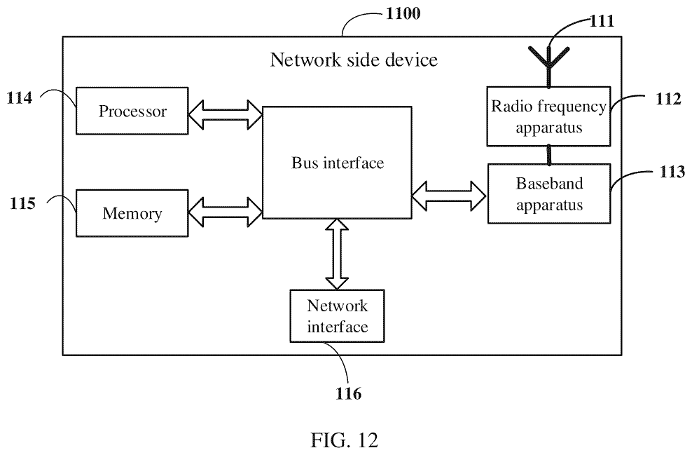

An embodiment of this application further provides a network side device. As shown in FIG. 12, the network side device 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes to-be-sent information, and sends processed information to the radio frequency apparatus 112. After processing the received information, the radio frequency apparatus 112 sends processed information through the antenna 111.

The method performed by the network side device in the foregoing embodiment may be implemented in the baseband apparatus 113. The baseband apparatus 113 includes a baseband processor.

For example, the baseband apparatus 113 may include at least one baseband board. A plurality of chips are disposed on the baseband board. As shown in FIG. 12, one of the chips is, for example, the baseband processor, and is connected to the memory 115 by using a bus interface, to invoke a program in the memory 115 to perform an operation of a network device shown in the foregoing method embodiment.

The network side device may further include a network interface 116. For example, the interface is a common public radio interface (CPRI).

The network side device 1100 in this embodiment of the present application further includes instructions or a program that is stored in the memory 115 and that can be run on the processor 114. The processor 114 invokes the instructions or the program in the memory 115 to perform the method performed by the modules shown in FIG. 6, and a same technical effect is achieved. To avoid repetition, details are not described herein again.

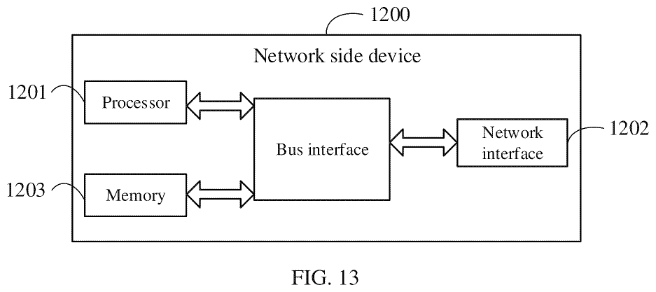

An embodiment of this application further provides a network side device. As shown in FIG. 13, the network side device 1200 includes a processor 1201, a network interface 1202, and a memory 1203. The network interface 1202 is, for example, a common public radio interface (CPRI).

The network side device 1200 in this embodiment of the present application further includes instructions or a program that is stored in the memory 1203 and that can be run on the processor 1201. The processor 1201 invokes the instructions or the program in the memory 1203 to perform the method performed by the modules shown in FIG. 4, and a same technical effect is achieved. To avoid repetition, details are not described herein again.

An embodiment of this application further provides a readable storage medium. The readable storage medium stores a program or an instruction. When the program or the instruction is executed by a processor, processes in the foregoing transmission control method embodiments can be implemented, and a same technical effect can be achieved. To avoid repetition, details are not described herein again.

The processor is a processor in the terminal device in the foregoing embodiments. The readable storage medium includes a computer-readable storage medium, such as a computer read-only memory ROM, a random access memory RAM, a magnetic disk, or an optical disc.

An embodiment of this application further provides a chip, where the chip includes a processor and a communication interface, the communication interface is coupled to the processor, and the processor is configured to run a program or an instruction to implement processes in the foregoing transmission control method embodiment, and a same technical effect can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes in the foregoing transmission control method embodiment, and a same technical effect can be achieved. To avoid repetition, details are not described herein again.

An embodiment of this application further provides a transmission control system, including a terminal device and a network side device. The terminal may be configured to perform the steps of the transmission control method according to the second aspect, and the network side device may be configured to perform the steps of the transmission control method according to the first aspect.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a. . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

1. A method for transmission control, comprising:
sending, by a target device, first control signaling to a remote device through a direct path between the target device and the remote device, wherein the first control signaling comprises a first indication used for activating or deactivating duplication transmission of a target bearer of the remote device,
wherein the target bearer is a bearer for at least two transmission paths of the remote device, and the at least two transmission paths comprise the direct path and at least one indirect path between the target device and the remote device.

2. The method according to claim 1, wherein before the sending, by the target device, the control signaling to the remote device through the direct path between the target device and the remote device, the method further comprises:
sending, by the target device, configuration information to the remote device, wherein the configuration information is used for configuring at least two transmission paths for the target bearer of the remote device.

3. The method according to claim 2, wherein the configuration information comprises at least one of the following:
a third indication, wherein the third indication indicates to configure duplication transmission for the target bearer and configure an initial state of the duplication transmission as an active state or an inactive state; or
a fourth indication, wherein the fourth indication indicates a primary path in the at least two transmission paths of the target bearer.

4. The method according to claim 1, wherein the first indication comprises a first bearer identifier and a first sequence, and the first sequence comprises a duplication transmission parameter of a target bearer corresponding to the first bearer identifier; and
a value of the duplication transmission parameter being a first value indicates to activate duplication transmission of the target bearer corresponding to the duplication transmission parameter; or
a value of the duplication transmission parameter being a second value indicates to deactivate duplication transmission of the target bearer corresponding to the duplication transmission parameter.

5. The method according to claim 1, wherein the first indication comprises a first parameter, and a value of the first parameter being a first value indicates to activate duplication transmission of all target bearers in a signaling radio bearer or a data radio bearer of the remote device; or
a value of the first parameter being a second value indicates to deactivate duplication transmission of all target bearers in a signaling radio bearer or a data radio bearer of the remote device.

6. The method according to claim 4, wherein the first indication further comprises a first path identifier, and the first path identifier indicates transmission paths that are in all transmission paths of the target bearer and that participate in duplication transmission.

7. The method according to claim 4, wherein the first indication further comprises a second sequence, and the second sequence comprises a second parameter corresponding to each transmission path of the target bearer; and
a value of the second parameter being a first value indicates that a transmission path corresponding to the second parameter participates in duplication transmission; or
a value of the second parameter being a second value indicates that a transmission path corresponding to the second parameter does not participate in duplication transmission.

8. A network side device, comprising: a memory storing instructions; and a processor coupled to the memory, wherein the instructions, when executed by the processor, cause the processor to perform operations comprising:
sending first control signaling to a remote device through a direct path between the network side device and the remote device, wherein the first control signaling comprises a first indication used for activating or deactivating duplication transmission of a target bearer of the remote device,
wherein the target bearer is a bearer for at least two transmission paths of the remote device, and the at least two transmission paths comprise the direct path and at least one indirect path between the network side device and the remote device.

9. The network side device according to claim 8, wherein before the sending the control signaling to the remote device through the direct path between the network side device and the remote device, the operations further comprise:
sending configuration information to the remote device, wherein the configuration information is used for configuring at least two transmission paths for the target bearer of the remote device.

10. The network side device according to claim 9, wherein the configuration information comprises at least one of the following:
a third indication, wherein the third indication indicates to configure duplication transmission for the target bearer and configure an initial state of the duplication transmission as an active state or an inactive state; or
a fourth indication, wherein the fourth indication indicates a primary path in the at least two transmission paths of the target bearer.

11. The network side device according to claim 8, wherein the first indication comprises a first bearer identifier and a first sequence, and the first sequence comprises a duplication transmission parameter of a target bearer corresponding to the first bearer identifier; and
a value of the duplication transmission parameter being a first value indicates to activate duplication transmission of the target bearer corresponding to the duplication transmission parameter; or
a value of the duplication transmission parameter being a second value indicates to deactivate duplication transmission of the target bearer corresponding to the duplication transmission parameter.

12. The network side device according to claim 8, wherein the first indication comprises a first parameter, and a value of the first parameter being a first value indicates to activate duplication transmission of all target bearers in a signaling radio bearer or a data radio bearer of the remote device; or
a value of the first parameter being a second value indicates to deactivate duplication transmission of all target bearers in a signaling radio bearer or a data radio bearer of the remote device.

13. The network side device according to claim 11, wherein the first indication further comprises a first path identifier, and the first path identifier indicates transmission paths that are in all transmission paths of the target bearer and that participate in duplication transmission.

14. The network side device according to claim 11, wherein the first indication further comprises a second sequence, and the second sequence comprises a second parameter corresponding to each transmission path of the target bearer; and
a value of the second parameter being a first value indicates that a transmission path corresponding to the second parameter participates in duplication transmission; or
a value of the second parameter being a second value indicates that a transmission path corresponding to the second parameter does not participate in duplication transmission.

15. A non-transitory computer-readable storage medium storing instructions that, when executed by a processor, cause the processor to perform operations comprising:
sending, by a target device, first control signaling to a remote device through a direct path between the target device and the remote device, wherein the first control signaling comprises a first indication used for activating or deactivating duplication transmission of a target bearer of the remote device,
wherein the target bearer is a bearer for at least two transmission paths of the remote device, and the at least two transmission paths comprise the direct path and at least one indirect path between the target device and the remote device.

16. The non-transitory computer-readable storage medium according to claim 15, wherein before the sending, by the target device, the control signaling to the remote device through the direct path between the target device and the remote device, the method further comprises:
sending, by the target device, configuration information to the remote device, wherein the configuration information is used for configuring at least two transmission paths for the target bearer of the remote device.

17. The non-transitory computer-readable storage medium according to claim 16, wherein the configuration information comprises at least one of the following:
a third indication, wherein the third indication indicates to configure duplication transmission for the target bearer and configure an initial state of the duplication transmission as an active state or an inactive state; or
a fourth indication, wherein the fourth indication indicates a primary path in the at least two transmission paths of the target bearer.

18. The non-transitory computer-readable storage medium according to claim 15, wherein the first indication comprises a first bearer identifier and a first sequence, and the first sequence comprises a duplication transmission parameter of a target bearer corresponding to the first bearer identifier; and
a value of the duplication transmission parameter being a first value indicates to activate duplication transmission of the target bearer corresponding to the duplication transmission parameter; or
a value of the duplication transmission parameter being a second value indicates to deactivate duplication transmission of the target bearer corresponding to the duplication transmission parameter.

19. The non-transitory computer-readable storage medium according to claim 15, wherein the first indication comprises a first parameter, and a value of the first parameter being a first value indicates to activate duplication transmission of all target bearers in a signaling radio bearer or a data radio bearer of the remote device; or
a value of the first parameter being a second value indicates to deactivate duplication transmission of all target bearers in a signaling radio bearer or a data radio bearer of the remote device.

20. The non-transitory computer-readable storage medium according to claim 18, wherein the first indication further comprises a first path identifier, and the first path identifier indicates transmission paths that are in all transmission paths of the target bearer and that participate in duplication transmission.
